(19) United States
(12) Patent Application Publication
(10) Pub. No.: US 2025/0233264 A1
(43) Pub. Date: Jul. 17, 2025

(54) SOLID-STATE SECONDARY BATTERY

(71) Applicant: HONDA MOTOR CO., LTD., Tokyo (JP)

(72) Inventors: Takashi NAKAGAWA, Saitama (JP); Kyohei IZUMI, Saitama (JP)

(21) Appl. No.: 18/966,137

(22) Filed: Dec. 3, 2024

(30) Foreign Application Priority Data
Jan. 11, 2024 (JP) 2024-002645

(51) Int. Cl. H01M 50/431; H01M 10/0525; H01M 50/443; H01M 50/449; H01M 50/491

(52) U.S. Cl. CPC H01M 50/431; H01M 10/0525; H01M 50/443; H01M 50/449; H01M 50/491

(57) ABSTRACT

Provided is a solid-state secondary battery having an intermediate layer allowing rapid charging and providing desirable charge-discharge efficiency. A solid-state secondary battery includes: a positive electrode layer; a negative electrode layer including at least a negative electrode current collector; a solid electrolyte layer containing a solid electrolyte material; an intermediate layer provided between the negative electrode layer and the solid electrolyte layer, and a buffer material that constrains an electrode assembly formed by joining the positive electrode layer, the solid electrolyte layer, the intermediate layer, and the negative electrode layer, in which the buffer material has a 25% compression load of more than 0.5 MPa and an elongation of less than 100%.

This application is based on and claims the benefit of priority from Japanese Patent Application No. 2024-002645, filed on 11 Jan. 2024, the content of which is incorporated herein by reference.

### BACKGROUND OF THE INVENTION

### Field of the Invention

The present invention relates to a solid-state secondary battery.

### Related Art

In recent years, research and development on secondary batteries that contribute to energy efficiency has been conducted to enable more people to access affordable, reliable, sustainable, and advanced energy.

As such secondary batteries, there have been known solid-state secondary batteries, such as lithium metal batteries and lithium-ion secondary batteries, with a solid electrolyte layer being disposed between a positive electrode layer and a negative electrode layer. An intermediate layer may be disposed between the negative electrode layer and the solid electrolyte layer in order to achieve uniform deposition of lithium or the like to stabilize an interface.

In solid-state secondary batteries, there is a demand for improving charge-discharge efficiency. For example, PCT International Publication No. WO2022/254796 discloses a technology for improving both the charge-discharge efficiency and discharge capacity.
Patent Document 1: PCT International Publication No. WO2022/254796

### SUMMARY OF THE INVENTION

As a solution to an issue that lithium titanate used for the negative electrode has a small capacity per mass, PCT International Publication No. WO2022/254796 proposes an electrode material including a first active material containing Li, Ti, and O, a second active material containing Mo and O, and a solid electrolyte. The solid-state secondary battery having an intermediate layer also has an issue that current density distribution becomes uneven when rapid charging is performed, resulting in higher resistance or a short circuit in the battery.

The present invention has been made in view of the above-stated issues and aims at providing a solid-state secondary battery having an intermediate layer allowing rapid charging and providing desirable charge-discharge efficiency.

(1) An aspect of the present invention relates to a solid-state secondary battery, including: a positive electrode layer; a negative electrode layer including at least a negative electrode current collector; a solid electrolyte layer containing a solid electrolyte material; an intermediate layer provided between the negative electrode layer and the solid electrolyte layer; and a buffer material that constrains an electrode assembly formed by joining the positive electrode layer, the solid electrolyte layer, the intermediate layer, and the negative electrode layer, in which the buffer material has a 25% compression load of more than 0.5 MPa and an elongation of less than 100%.

The aspect (1) of the invention can provide a solid-state secondary battery having an intermediate layer allowing rapid charging and providing desirable charge-discharge efficiency.

(2) The solid-state secondary battery according to the aspect (1), in which a material constituting the intermediate layer and the solid electrolyte material are each particulate, and particles constituting the intermediate layer are smaller in size than particles of the solid electrolyte material.

The aspect (2) of the invention can increase a contact area between the intermediate layer and the solid electrolyte layer and enhance the adhesiveness of these layers.

(3) The solid-state secondary battery according to the aspect (1) or (2), in which the intermediate layer has a porosity of 40% to 70%.

The aspect (3) of the invention makes it possible to maintain interface adhesiveness and enhance the durability of the solid-state secondary battery even when charging and discharging are repeated.

(4) The solid-state secondary battery according to any one of the aspects (1) to (3), in which the intermediate layer has a composite elastic modulus of less than 1 GPa.

According to the aspect (4) of the invention, the intermediate layer makes it possible to adapt to the change in thickness of the solid-state secondary battery caused by charging and discharging, so that the interface adhesiveness can be maintained and the durability of the solid-state secondary battery can be enhanced.

(5) The solid-state secondary battery according to any one of the aspects (1) to (4), in which the intermediate layer contains amorphous carbon.

The aspect (5) of the invention makes it possible to reduce dendrite formation and to enhance cycle characteristics of the solid-state secondary battery.

(6) The solid-state secondary battery according to any one of the aspects (1) to (5), in which the buffer material has a compressive residual strain of 6% or more.

According to the aspect (6) of the invention, the buffer material can easily adapt to the change in thickness of the solid-state secondary battery during charging and discharging, so that uniform reaction distribution can be achieved.

### BRIEF DESCRIPTION OF THE DRAWINGS

FIG. 1 is a schematic sectional view showing the configuration of a solid-state secondary battery according to an embodiment of the present invention;

FIG. 2 is a diagram showing the configuration of a constraint jig for the solid-state secondary battery according to the embodiment of the present invention;

FIG. 3 is a graph showing charging characteristics of the solid-state secondary battery according to the embodiment of the present invention; and

FIG. 4 is a graph showing the charging characteristics of the solid-state secondary battery according to the embodiment of the present invention.

### DETAILED DESCRIPTION OF THE INVENTION

### [Solid-state Secondary Battery]

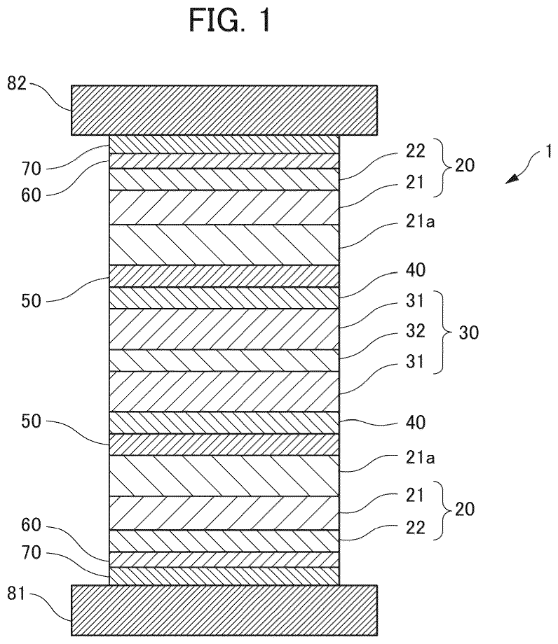

As shown in FIG. 1, a solid-state secondary battery 1 includes an electrode assembly formed by laminating and joining a negative electrode layer 20, an intermediate layer 50, a solid electrolyte layer 40, and a positive electrode layer 30 in this order. In the present embodiment, the electrode assembly of the solid-state secondary battery 1 is described to have a structure in which the negative electrode layer 20, the intermediate layer 50, the solid electrolyte layer 40, the positive electrode layer 30, another solid electrolyte layer 40, another intermediate layer 50, and another negative electrode layer 20 are laminated in this order as shown in FIG. 1. However, the electrode assembly is not limited to the above structure, and may have the negative electrode layer 20, the solid electrolyte layer 40, the positive electrode layer 30, and the intermediate layer 50 provided between the negative electrode layer 20 and the solid electrolyte layer 40. The solid-state secondary battery 1 includes a buffer material 70 that constrains the electrode assembly. The buffer material 70 can appropriately constrain the electrode assembly.

The solid-state secondary battery 1 is not particularly limited and may be a lithium ion solid-state secondary battery or a lithium metal secondary battery.

### (Negative Electrode)

The negative electrode layer 20 includes at least a negative electrode current collector layer 22. The negative electrode layer 20 may further include a negative electrode active material layer 21.

The negative electrode current collector layer 22 is not particularly limited and may be made of copper, nickel, stainless steel, etc. Examples of the shape of the negative electrode current collector layer 22 may include a foil shape, a plate shape, a mesh shape, a nonwoven fabric shape, a foamed shape, and the like.

The negative electrode active material layer 21 is not particularly limited and may be made of a material that can be used as a negative electrode active material for a solid electrode. The negative electrode active material layer 21 is preferably a lithium metal layer in which the negative electrode active material is lithium metal. This is because the solid-state secondary battery 1 according to the present invention can adhere to the solid electrolyte layer 40 with high adhesion force even when the negative electrode active material layer 21 is a hard metal. The lithium metal includes, in addition to lithium metal elements, lithium alloys or the like. In addition to the above, the negative electrode active material layer 21 may be made of a silicon based active material such as Si and Si alloys, lithium transition metal oxides such as lithium titanate (Li₄Ti₅O₁₂), transition metal oxides such as TiO₂, Nb₂O₃, and WO₃, metal sulfides, metal nitrides, graphite, carbon materials such as soft carbon and hard carbon, metal indium, etc.

The negative electrode active material layer 21 may contain other materials that can be contained in the negative electrode active material layer of the solid battery. Examples of the other materials may include a solid electrolyte, a conductive assistant, a binder, and the like. Examples of the solid electrolyte may include a solid electrolyte similar to the solid electrolyte contained in the solid electrolyte layer 40, which will be described later. Examples of the conductive assistant may include carbon black, natural graphite, carbon fiber, carbon nanotubes, and the like. Examples of the binder may include nitrile based polymers, polyester based polymers, acrylic acid based polymers, cellulose based polymers, styrene based polymers, styrene-butadiene based polymers, vinyl acetate based polymers, urethane based polymers, fluoroethylene based polymers, and the like.

When the solid-state secondary battery 1 is a lithium metal secondary battery using metallic lithium as the negative electrode active material, the solid-state secondary battery 1 may be an anode-free battery that is free from the negative electrode active material layer 21 at initial charging. In this case, a lithium metal layer as the negative electrode active material layer 21 is formed after the initial charging and discharging.

When the solid-state secondary battery 1 is a lithium metal secondary battery using metallic lithium as the negative electrode active material, a lithium deposition layer 21a is generated during charging of the solid-state secondary battery 1. The lithium deposition layer 21a is generated when lithium ions released from a positive electrode active material layer 31 are deposited on the surface of the negative electrode active material layer 21 during charging of the solid-state secondary battery. On the other hand, during discharging, lithium ions are released from the lithium deposition layer 21a and absorbed into the positive electrode active material layer 31. Therefore, the lithium deposition layer 21a may become thinner or disappear during discharging of the solid-state secondary battery.

### (Intermediate Layer)

The intermediate layer 50 is disposed between the negative electrode layer 20 and the solid electrolyte layer 40. The intermediate layer 50 has pores that allow metal ions (e.g. lithium ions) serving as charge transfer media for the solid-state secondary battery 1 to pass through. When the solid-state secondary battery 1 is, for example, a lithium metal battery, lithium metal can be deposited uniformly by allowing the lithium ions to pass through the intermediate layer 50. In addition, since the intermediate layer 50 has pores and has flexibility, it can adapt to the change in thickness of the solid-state secondary battery 1 caused by charging and discharging. Therefore, even after the solid-state secondary battery 1 is charged and discharged repeatedly, it is possible to maintain interface adhesiveness and to enhance the durability of the solid-state secondary battery.

The intermediate layer 50 preferably has a porosity of 40% to 70%. The porosity of the intermediate layer 50 can be given by the following expression (1), for example. In the expression (1), a “filling factor” refers to the percentage of the density of a molded intermediate layer relative to the true density. Porosity (%)=(100−filling factor (8)) (1)

The intermediate layer 50 preferably has a composite elastic modulus of less than 1 GPa from the viewpoint of obtaining the above-mentioned preferable flexibility. The composite elastic modulus of the intermediate layer 50 may be in the range of 600 MPa to 800 MPa.

Examples of the material constituting the intermediate layer 50 may include, but not limited to, amorphous carbon, metals that can be alloyed with lithium, and the like. The intermediate layer 50 preferably contains amorphous carbon. The intermediate layer 50 may contain a binder in addition to the above material.

For example, unlike graphite or the like, the amorphous carbon is difficult to be alloyed by reaction with metal such as lithium, which makes it possible to reduce dendrite formation and to enhance the cycle characteristics of the solid-state secondary battery 1. The amorphous carbon may be easily graphitizable carbon (soft carbon) or hardly graphitizable carbon (hard carbon). Amorphous carbon may be an allotrope of carbon that does not exhibit a clear crystalline state, and may be an aggregate of graphite microcrystals. Specific examples of the amorphous carbon may include carbon blacks such as acetylene black, furnace black, and Ketchen black, coke, activated carbon, carbon nanotubes (CNT), fullerene, and graphene.

Metals that can be alloyed with lithium may include tin (Sn), silicon (Si), zinc (Zn), magnesium (Mg), gold (Au), platinum (Pt), palladium (Pd), silver (Ag), aluminum (Al), bismuth (Bi), antimony (Sb), and the like. Metals that can be alloyed with lithium may be nanoparticles.

The material constituting the intermediate layer 50 may be a combination of a plurality of types of materials described above.

The material constituting the intermediate layer 50 is particulate, and its particles are preferably smaller in size than the particles of the solid electrolyte material constituting the solid electrolyte layer 40. As a result, the particles constituting the intermediate layer 50 can enter between the solid electrolyte materials that constitute the interface between the intermediate layer 50 and the solid electrolyte layer 40. This makes it possible to increase a contact area between the intermediate layer 50 and the solid electrolyte layer 40 and enhance the adhesiveness of these layers. Amorphous carbon may have a particle size in the range of 0.02 μm to 0.06 μm in median diameter (D50), for example. Metal nanoparticles may have a particle size in the range of 0.06 μm to 0.1 μm in median diameter (D50), for example.

### (Solid Electrolyte Layer)

The solid electrolyte layer 40 is provided between the intermediate layer 50 and the positive electrode layer 30. A solid electrolyte material constituting the solid electrolyte layer 40 is not particularly limited and may be a material that can be used as an electrolyte of the solid-state secondary battery. Examples of the solid electrolyte material may include a sulfide solid electrolyte material, an oxide solid electrolyte material, a nitride solid electrolyte material, a halide solid electrolyte material, and the like.

Examples of the sulfide solid electrolyte material may include Li₂S—P₂S₅, Li₂S—P₂S₅-liI, and the like. The description of “Li₂S—P₂S₅” above refers to a sulfide solid electrolyte material made of a raw material composition containing Li₂S and P₂S₅, and this shall apply to other similar descriptions. The sulfide solid electrolyte material may have an argyrodite-type crystal structure.

Examples of the oxide solid electrolyte material may include NASICON-type oxides, garnet-type oxides, perovskite-type oxides, and the like. Examples of the NASICON-type oxides may include oxides containing Li, Al, Ti, P and O (e.g. Li_{1.5}Al_{0.5}Ti_{1.5} (PO₄)₃). Examples of the garnet-type oxides may include oxides containing Li, La, Zr and O (e.g. Li₇La₃Zr₂O₁₂). Examples of the perovskite-type oxides may include oxides containing Li, La, Ti and O (e.g. LiLaTiO₃).

The solid electrolyte material constituting the solid electrolyte layer 40 is preferably particulate. The solid electrolyte material preferably has a particle size of, for example, 0.5 μm to 10 μm in median diameter (D50) that is larger than the particles constituting the intermediate layer 50.

In addition to the solid electrolyte material, the solid electrolyte layer 40 may contain a material that can be used in the solid electrolyte layer of the solid-state secondary battery. For example, the solid electrolyte layer 40 may contain a binder. As a binder, a material similar to the binder that can be contained in the negative electrode active material layer 21 can be used.

The solid electrolyte layer 40 may have a porous substrate inside. As the porous substrate, woven, and non-woven fabrics can be used, for example. The porous substrate included in the solid electrolyte layer 40 enhances the strength of the solid electrolyte layer 40.

### (Positive Electrode Layer)

The positive electrode layer 30 includes the positive electrode active material layer 31 and a positive electrode current collector layer 32. In the present embodiment, the positive electrode layer 30 has a configuration in which each of two positive electrode active material layers 31 is laminated on each side of one positive electrode current collector layer 32. On the other hand, the positive electrode layer 30 is not limited to the above configuration and may have a configuration in which one positive electrode active material layer 31 is laminated on one side of a single positive electrode current collector layer 32.

The positive electrode active material layer 31 is not particularly limited and may be made of a material that can be used as a positive electrode active material of a solid electrode. Examples of the positive electrode active material constituting the positive electrode active material layer 31 may include a layered active material containing lithium, a spinel type active material, an olivine type active material, and the like. Specific examples of the positive electrode active material may include lithium cobalt oxide (LiCoO₂), lithium nickelate (LiNi O₂), LiNiₚMn_{q}CoᵣO₂ (p+q+r=1), LiNiₚAl_{q}CoᵣO₂ (p+q+r=1), Lithium manganate (LiMn₂O₄), different kind element substituent Li—Mn spinel expressed by Li₁+ₓMn_{2-x-y}MO4 (x+y=2, M=at least one selected from Al, Mg, Co, Fe, Ni, and Zn), lithium titanate (oxides containing Li and Ti), lithium metal phosphate (LiMPO₄, M=at least one selected from Fe, Mn, Co, and Ni), and the like.

The positive electrode active material layer 31 may optionally contain a solid electrolyte or a conductive assistant. In addition, from the viewpoint of providing flexibility, the positive electrode active material layer 31 may optionally contain a binder. There are no particular limits on the solid electrolyte, the conductive assistant, and the binder, and materials that can be used for the positive electrode layer of the solid-state secondary battery can be used.

The positive electrode current collector layer 32 is not particularly limited and may be made of, for example, aluminum, aluminum alloys, stainless steel, nickel, iron, titanium, conductive carbon (such as graphite and carbon nanotube), etc. Examples of the shape of the positive electrode current collector layer 32 may include a foil shape, a plate shape, a mesh shape, a nonwoven fabric shape, a foamed shape, and the like.

The electrode assembly constituted of the respective layers described above is housed in an outer casing 60. The outer casing 60 can be expanded and contracted according to the change in thickness of the electrode assembly caused by charging and discharging. As a material that constitutes the outer casing 60, a laminate film can be used, for example. As the laminate film, a laminate film with a three-layer structure can be used, in which an inner resin layer, a metal layer, and an outer resin layer are laminated in this order from the inside. The outer resin layer may be, for example, a polyamide (nylon) layer or a polyethylene terephthalate (PET) layer, the metal layer may be, for example, an aluminum layer, and the inner resin layer may be, for example, a polyethylene layer or a polypropylene layer.

### (Buffer Material)

The buffer material 70 is a member that constrains the solid-state secondary battery 1. In the present embodiment, the solid-state secondary battery 1 is in contact with the buffer material 70 at both ends in the lamination direction (up-down direction in FIG. 1). In this state, the solid-state secondary battery 1 is constrained under the pressure applied from both ends in the lamination direction toward a center position. Properly constraining the solid-state secondary battery 1 with the buffer material 70 makes it possible to quickly charge the solid-state secondary battery 1. In addition, generation of a short circuit and the like can be reduced and desirable charge-discharge efficiency can be achieved.

The buffer material 70 has a 25% compression load of more than 0.5 MPa. As a result, the surface pressure distribution over the solid-state secondary battery 1 can be made uniform, which uniformizes the thickness of lithium metal deposition. The 25% compression load of the buffer material 70 can be measured by a method that conforms to JIS K 6254. The buffer material 70 may have a 25% compression load of more than 1.0 MPa.

The buffer material 70 has an elongation of less than 100%. This makes it possible to easily adapt to the change in thickness of the solid-state secondary battery 1 during charging and discharging. The elongation of the buffer material 70 can be measured by a method that conforms to the measurement method of “elongation at break” specified in JIS K 6251. Specifically, the elongation (%) at break can be calculated by an expression “(distance between marked lines at break−distance between the marked lines before test)/distance between the marked lines before test×100”.

The buffer material 70 preferably has a compressive residual strain of 6% or more. This allows the buffer material 70 to easily adapt to the change in thickness of the solid-state secondary battery 1 during charging and discharging. The compressive residual strain of the buffer material 70 can be measured by a method that conforms to JIS K 6401.

The constraining pressure of the buffer material 70 that constrains the solid-state secondary battery 1 may be set to 3 MPa or less or may be set to 1 MPa or less at 25° C. The buffer material 70 can provide a favorable adaptability to the change in thickness of the solid-state secondary battery 1 during charging and discharging. Therefore, even with the constraining pressure of the solid-state secondary battery 1 being set as the above condition, an effective reaction area can be maintained and rapid charging is enabled.

### [Method of Manufacturing Solid-state Secondary Battery]

The method of manufacturing the solid-state secondary battery 1 described above is not particularly limited, and a typical method of manufacturing a solid-state secondary battery can be used. For example, there is a method in which the respective layers described above are laminated and are press-joined into an electrode assembly by a device such as a roll press device or a flat press device, and then the electrode assembly is housed in an outer casing and constrained by the buffer material 70.

### [Constraint jig for Solid-state Secondary Battery]

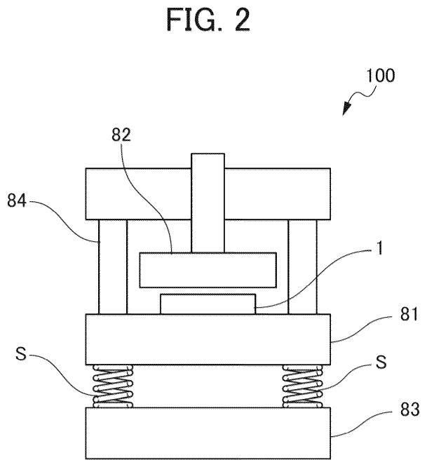

As a method of disposing the buffer material 70 on both the laminated end surfaces of the solid-state secondary battery 1 and applying pressure thereto to constrain the solid-state secondary battery 1, there is a method involving the use of a constraint jig 100 shown in FIG. 2. For example, the constraint jig 100 includes, as shown in FIG. 2, a pedestal 81, a pressing part 82, a base part 83, and a housing part 84.

As shown in FIGS. 1 and 2, the buffer material 70 is disposed on both the laminated end surfaces of the solid-state secondary battery 1 disposed on the pedestal 81. In this state, the pressing part 82 applies pressure to the solid-state secondary battery 1 from above. The pedestal 81 and the base part 83 that comes into contact with an installation surface of the constraint jig 100 are coupled through spring S. Therefore, due to the pressure applied by the pressing part 82 and the reaction force of the spring S, a uniform pressure is applied to the solid-state secondary battery 1 in a lamination direction from both the laminated end surfaces. The solid-state secondary battery 1 can be constrained under a predetermined pressure when the pressing part 82 is fixed while the predetermined pressure is applied to the solid-state secondary battery 1. The pressing part 82 has a pressure surface larger than the laminated surfaces of the solid-state secondary battery. A portion of the pressing part 82 extends outward from the housing part 84 that houses the solid-state secondary battery 1 and is configured to be slidable in an up-down direction. The pressing part 82 is fixed to the housing part 84 while, for example, the predetermined constraining pressure is applied to the solid-state secondary battery 1.

The above description is one example of a specific method of constraining the solid-state secondary battery 1, and the method of constraining the solid-state secondary battery 1 is not limited to the above.

While the preferred embodiment of the present invention has been described in the foregoing, the present invention is not limited to the embodiment disclosed. For example, in the above embodiment, the buffer material 70 has been described to be disposed on both the laminated surfaces of the solid-state secondary battery 1, though the buffer material 70 may be disposed on one of the laminated surfaces of the solid-state secondary battery 1. As an example that allows such configuration, there is a case where, for example, the solid-state secondary battery 1 includes the positive electrode layer 30 in which one positive electrode active material layer 31 is laminated on one side of a single positive electrode current collector layer 32. In the above configuration, for example, a solid electrolyte layer for pouch-sealing may be disposed between the positive electrode current collector layer 32 and the outer casing 60. In this way, when a material having a buffering effect is disposed between the positive electrode current collector layer 32 and the outer casing 60, the buffer material 70 need not be deposited on the side of the positive electrode layer 30.

Hereinafter, the present invention will be described in more detail with reference to examples. The present invention is not limited to the examples described below.

### EXAMPLES

### Example 1

### [Fabrication of Positive Electrode Layer]

As a positive electrode current collector, aluminum foil with a thickness of 15 μm was prepared.

80 parts by mass of lithium-nickel-cobalt-manganese composite oxide (NCM622) as a positive electrode active material, 17 parts by mass of argyrodite-type sulfide solid electrolyte as a solid electrolyte, 2 parts by mass of carbon black as a conductive assistant, and 1 part by mass of styrene butadiene rubber (SBR) based binder as a binding material were mixed. A resultant mixture was dispersed in 43 parts by mass of butyl butyrate to prepare a positive electrode active material layer. The obtained positive electrode active material layer slurry was applied to both sides of the positive electrode current collector using a bar coater so as to have a mass per unit area of 27 mg/cm² after drying, and was dried to form a positive electrode active material layer with a thickness of 80 μm for fabrication of the positive electrode layer.

### [Fabrication of Solid Electrolyte Layer Transfer Sheet]

97 parts by mass of argyrodite-type sulfide solid electrolyte (median diameter of 3.0 μm) and 3 parts by mass of a binder were mixed. A resultant mixture was dispersed in a solvent to prepare a solid electrolyte slurry. The obtained solid electrolyte slurry was dried to fabricate a solid electrolyte layer transfer sheet.

### [Fabrication of Negative Electrode Layer]

As a negative electrode current collector, copper foil with a thickness of 10 μm was prepared. On the surface of the copper foil, metal lithium foil with a thickness of 40 μm was rolled and laminated to fabricate a negative electrode layer.

### [Fabrication of Intermediate Layer Transfer Sheet]

A total of 95 parts by mass of Sn particles (average particle size: 0.07 μm) as metal particles and acetylene black (average particle size: 0.05 μm) as amorphous carbon particles were mixed with 5 parts by mass of a PVDF-based binder as a binding material. A resultant mixture was dispersed in 1000 parts by mass of N-methyl-2-pyrrolidone (NMP) to prepare an intermediate layer slurry. The obtained intermediate layer slurry was applied to a support sheet and dried so as to have a final sickness of 3.0 μm for fabrication of an intermediate layer transfer sheet.

### [Fabrication of Solid-state Secondary Battery]

A solid electrolyte layer in the solid electrolyte layer transfer sheet was superimposed on the surface of the positive electrode active material layer in the positive electrode layer, and the solid electrolyte layer and the positive electrode active material layer were joined using a uniaxial molding press device under joining conditions including joining pressure: 90 MPa, joining time: 3 minutes, and joining temperature: room temperature. Then, the support sheet for the solid electrolyte layer transfer sheet was peeled off to obtain a positive electrode layer-solid electrolyte layer assembly. Next, an intermediate layer in the intermediate layer transfer sheet was superimposed on the surface of the solid electrolyte layer in a positive electrode layer-solid electrolyte layer assembly, and the solid electrolyte layer and the intermediate layer were joined using a uniaxial molding press device under joining conditions including joining pressure: 290 MPa, joining time: 5 minutes, and joining temperature: room temperature. Then, the support sheet for the intermediate layer transfer sheet was peeled off to obtain a positive electrode layer-solid electrolyte layer-intermediate layer assembly. Next, using an isotropic pressure molding press device, a combined body of the positive electrode layer-solid electrolyte layer-intermediate layer assembly was densified under joining pressure: 980 MPa, :joining time: 5 minutes, and joining temperature: 120° C. Next, metallic lithium foil for a negative electrode layer was superimposed on the surface of the intermediate layer in the positive electrode layer-solid electrolyte layer-intermediate layer assembly, and the intermediate layer and the metallic lithium foil were joined using a uniaxial molding press device under joining conditions including joining pressure: 180 MPa, joining time: 2 minutes, and joining temperature: room temperature. In this way, an electrode laminate was obtained. The electrode assembly was housed in an aluminum laminate film outer casing, and was constrained under a constraining pressure of 3 MPa with a polyurethane foam (PORON MX-48HF made by Rogers Inoac Corporation) disposed as a buffer on the negative electrode layer side.

### Example 2

A solid-state secondary battery according to an example 2 was fabricated in the same way as in the example 1 except that the constraining pressure of the solid-state secondary battery was set to 1 MPa.

### Comparative Example 1

A solid-state secondary battery according to a comparative example 1 was fabricated in the same way as in the example 1 except that polyurethane foam (PORON CH-48EG made by Rogers Inoac Corporation) was used as a buffer material.

### Comparative Example 2

A solid-state secondary battery according to a comparative example 2 was fabricated in the same way as in the example 1 except that polyurethane foam (PORON SA-30 made by Rogers Inoac Corporation) was used as a buffer material.

### Comparative Example 3

A solid-state secondary battery according to a comparative example 3 was fabricated in the same way as in the example 1 except that the intermediate layer was not disposed.

### Comparative Example 4

A solid-state secondary battery according to a comparative example 4 was fabricated in the same way as in the example 2 except that the intermediate layer was not disposed.

### [Measurement of Physical Properties of Buffer Material]

Physical properties of the buffer material, including elongation (%) at break, 25% compression load (MPa), and compressive residual strain (%), used in the respective examples and comparative examples were measured. The elongation (%) at break was measured by a method that conforms to JIS K 6251. The 25% compression load (MPa) was measured by a method that conforms to JIS K 6254. The compressive residual strain (%) was measured by a method that conforms to JIS K 6401. The results are shown in Table 1.

TABLE 1

| | Buffer material | | | |
|---|---|---|---|---|
| | | | 25% | Compressive |
| | | Elongation | compression | residual |
| | | at brake | load | strain |
| | Type | (%) | (MPa) | (%) |
| Example 1 | MX-48HF | 80 | 1.37 | 8 |
| Example 2 | MX-48HF | 80 | 1.37 | 8 |
| Comparative | CH-48EG | 120 | 0.31 | 2.4 |
| Example 1 | | | | |
| Comparative | SA-30 | 133 | 0.07 | 0.8 |
| Example 2 | | | | |
| Comparative | MX-48HF | 80 | 1.37 | 8 |
| Example 3 | | | | |
| Comparative | MX-48HF | 80 | 1.37 | 8 |
| Example 4 | | | | |

[Charge and discharge Tests]

Charge and discharge tests were conducted using the solid-state secondary batteries according to the respective examples and comparative examples. There were five test conditions as follows: 60° C. at 0.1 C, 45° C. at 0.1 C, 45° C. at ⅓ C, 25° C. at ⅓ C, and 25° C. at 1.97 C. The charge and discharge tests were conducted in a voltage range from upper voltage of 4.3V to lower voltage of 2.65V, with constant current and constant voltage (CCCV) for charging and constant current (CC) for discharging. Charge-discharge evaluation results are shown in Table 2 and charge-discharge efficiency is shown in Table 3.

TABLE 2

| | Charge and discharge evaluation results | | | | |
|---|---|---|---|---|---|
| | 60° C. 0.1 C | 45° C. 0.1 C | 45° C. 1/3 C | 25° C. 1/3 C | 25° C. 1.97 C |
| Example 1 | 2 | 2 | 2 | 2 | 2 |
| Example 2 | 2 | 2 | 2 | 2 | 2 |
| Comparative | 2 | 2 | 1 | 1 | 1 |
| Example 1 | | | | | |
| Comparative | 2 | 1 | 1 | 1 | 1 |
| Example 2 | | | | | |
| Comparative | 2 | 2 | 1 | 1 | 1 |
| Example 3 | | | | | |
| Comparative | 2 | 2 | 1 | 1 | 1 |
| Example 4 | | | | | |

Charge-discharge evaluation criteria in Table 2 are as follows.
2: Charge and discharge are possible without a short circuit
1: Overcharging, charging abnormality, or a short circuit has occurred.

TABLE 3

| | Charge-discharge efficiency | | | | |
|---|---|---|---|---|---|
| | 60° C. 0.1 C | 45° C. 0.1 C | 45° C. 1/3 C | 25° C. 1/3 C | 25° C. 1.97 C |
| | (%) | (%) | (%) | (%) | (%) |
| Example 1 | 98.9 | 99.9 | 99.9 | 100.1 | 100.0 |
| Example 2 | 99.0 | 100.0 | 99.9 | 98.3 | 98.0 |
| Comparative | 99.0 | 99.7 | 58.9 | 35.7 | 9.6 |
| Example 1 | | | | | |
| Comparative | 99.0 | 20.4 | 23.2 | 21.5 | 8.1 |
| Example 2 | | | | | |
| Comparative | 98.9 | 99.7 | 29.3 | 20.3 | 4.0 |
| Example 3 | | | | | |
| Comparative | 98.5 | 98.7 | 15.0 | 11.2 | 1.6 |
| Example 4 | | | | | |

In Table 3, the percentage of discharge capacity to the first charge capacity under each test condition (discharge capacity/charge capacity×100) is used as charge-discharge efficiency.

From the results in Tables 2 and 3, it is clear that the solid-state secondary batteries according to the respective examples are free from occurrence of failure such as a short circuit and are able to perform charging and discharging with high charge-discharge efficiency even when the charge rate is increased to ⅓ C or more. In contrast, the results of the solid-state secondary batteries according to the respective comparative examples clearly indicate that failure such as a short circuit occurs and thereby the charge-discharge efficiency deteriorates, especially when the charge rate is increased to ⅓ C or more.

### [Charging Characteristics at 25° C.]

As the charging characteristics of the solid-state secondary batteries according to the respective examples and comparative examples at 25° C., a maximum allowable charge current density (mA/cm²) and a maximum allowable charge rate (C) were calculated. The results are shown in Table 4. The maximum allowable charge current density (mA/cm²) and the maximum allowable charge rate (C) were calculated from the charge current values, which are free from occurrence of overcharging, charge abnormality or a short circuit at 25° C. with the charge-discharge efficiency of 98% or more.

TABLE 4

25° C. charging characteristics

| | Maximum allowable | Maximum |
|---|---|---|
| | charge current | allowable |
| | density | charge rate |
| | (mA/cm²) | (C) |
| Example 1 | 7.5 | 2 |
| Example 2 | 7.5 | 2 |
| Comparative | 0.38 | 0.1 |
| Example 1 | | |
| Comparative | 0.38 | 0.1 |
| Example 2 | | |
| Comparative | 0.19 | 0.05 |
| Example 3 | | |
| Comparative | 0.19 | 0.05 |
| Example 4 | | |

As shown in Table 4, it is clear from the results that both the maximum allowable charge current density (mA/cm²) and the maximum allowable charge rate (C) of the solid-state secondary batteries according to the respective examples are higher than those of the solid-state secondary batteries according to the respective comparative examples.

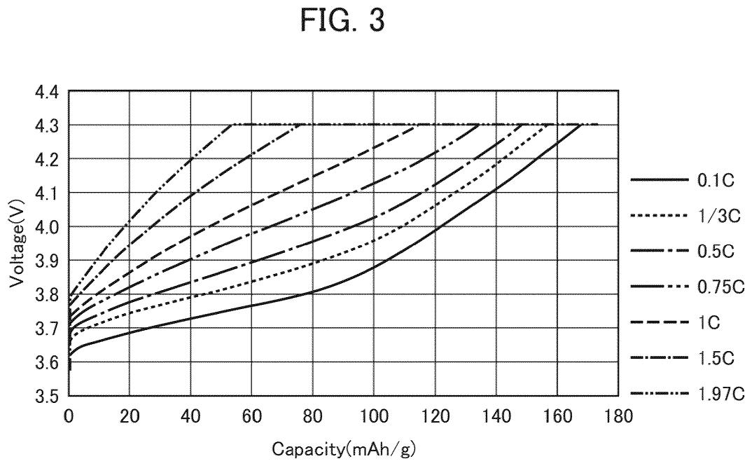

FIG. 3 is a graph showing the results of the charge and discharge tests performed using the solid-state secondary battery cell of the example 1 with the charge rate being varied at 25° C.

In FIG. 3, the vertical axis represents voltage (V) and the horizontal axis represents capacity (mAh/g). After the start of charging, a constant current (CC) was used for charging at each charge rate, and once the voltage reached 4.3V, charging was continued with control being switched to a constant voltage (CV). At each charge rate, charging was successful without the occurrence of failure such as a short circuit.

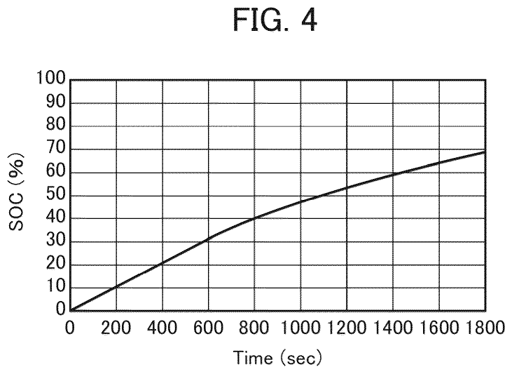

FIG. 4 is a graph showing SOC (%) when charging is performed using the solid-state secondary battery cell of the example 1 under CCCV at a charge rate of 1.97 C at 25° C. with an upper limit voltage of 4.3V. In FIG. 4, a full charge capacity when charging is performed at a charge rate of 0.1 C at 25° C. is defined to be 100%. As is clear from FIG. 4, charging up to SOC 68.7% is possible as a result of charging at a charge rate of 1.97 C for 30 minutes.

### EXPLANATION OF REFERENCE NUMERALS

1 Solid-state secondary battery
20 Negative electrode layer
30 Positive electrode layer
40 Solid electrolyte layer
50 Intermediate layer
60 Outer casing
70 Buffer material

What is claimed is:

1. A solid-state secondary battery, comprising:
a positive electrode layer;
a negative electrode layer including at least a negative electrode current collector;
a solid electrolyte layer containing a solid electrolyte material;
an intermediate layer provided between the negative electrode layer and the solid electrolyte layer, and
a buffer material that constrains an electrode assembly formed by joining the positive electrode layer, the solid electrolyte layer, the intermediate layer, and the negative electrode layer, wherein
the buffer material has a 25% compression load of more than 0.5 MPa and an elongation of less than 100%.

2. The solid-state secondary battery according to claim 1, wherein a material constituting the intermediate layer and the solid electrolyte material are each particulate, and
particles constituting the intermediate layer are smaller in size than particles of the solid electrolyte material.

3. The solid-state secondary battery according to claim 1, wherein the intermediate layer has a porosity of 40% to 70%.

4. The solid-state secondary battery according to claim 1, wherein the intermediate layer has a composite elastic modulus of less than 1 GPa.

5. The solid-state secondary battery according to claim 1, wherein the intermediate layer contains amorphous carbon.

6. The solid-state secondary battery according to claim 1, wherein the buffer material has a compressive residual strain of 6% or more.
